(19) United States
(12) Patent Application Publication
(10) Pub. No.: US 2008/0041156 A1
(43) Pub. Date: Feb. 21, 2008

(54) Semiconductor acceleration sensor

(75) Inventor: Kenji Katou, Miyazaki (JP)

Correspondence Address: TAKEUCHI & KUBOTERA, LLP, 200 DAINGERFIELD ROAD, SUITE 202, ALEXANDRIA, VA, 22314, US

(73) Assignee: Oki Electric Industry Co., Ltd.

(21) Appl. No.: 11/819,590

(22) Filed: Jun. 28, 2007

(30) Foreign Application Priority Data
Jul. 5, 2006 (JP) 2006-185895

(51) Int. Cl. G01P 15/18; G01P 15/12

(52) U.S. Cl. 73/514.33

(57) ABSTRACT

A semiconductor acceleration sensor includes an outer frame portion; a weight portion; a pair of X-axis flexible portions; a pair of Y-axis flexible portions; first to fourth X-axis resistor elements; first to fourth Y-axis resistor elements; and first to fourth Z-axis resistor elements. The first to fourth X-axis resistor elements are disposed on the X-axis flexible portions, and the first to fourth Y-axis resistor elements are disposed on the Y-axis flexible portions. The first to fourth Z-axis resistor elements are disposed on ones of the X-axis flexible portions and the Y-axis flexible portions. Further, the first and second Z-axis resistor elements are arranged symmetrically with respect to the third and fourth Z-axis resistor elements with a center point of the weight portion as a symmetrical point.

### BACKGROUND OF THE INVENTION AND RELATED ART STATEMENT

The present invention relates to a semiconductor acceleration sensor. More specifically, the present invention relates to a semiconductor acceleration sensor to be mounted on a mobile phone or a transport vehicle such as an automobile and an airplane for detecting three-axial acceleration in three axes, i.e., an X-axis, a Y-axis, and a Z-axis, crossing perpendicularly with each other.

In a conventional semiconductor acceleration sensor for detecting three-axial acceleration, a weight portion having a large thickness is disposed at a center portion of an outer frame portion formed of silicon. A pair of X-axis flexible portions and a pair of Y-axis flexible portions are disposed between the weight portion and the outer frame portion for connecting the weight portion and the outer frame portion. The X-axis flexible portions and the Y-axis flexible portions are arranged such that centerlines thereof in a width direction are aligned with an X-axis and a Y-axis crossing perpendicularly at a center portion of the weight portion, i.e., a weight center.

In the conventional semiconductor acceleration sensor, in order to detect an acceleration component in the Y-axis direction, a first Y-axis resistor element is disposed on the centerline of one of the Y-axis flexible portions on a side of the outer frame portion, and a second Y-axis resistor element is disposed on the centerline of the one of the Y-axis flexible portions on a side of the weight portion. Further, in order to detect the acceleration component in the Y-axis direction, a third Y-axis resistor element is disposed on the centerline of the other of the Y-axis flexible portions on the side of the weight portion, and a fourth Y-axis resistor element is disposed on the centerline of the other of the Y-axis flexible portions on the side of the outer frame portion.

Further, in the conventional semiconductor acceleration sensor, in order to detect acceleration components in the X-axis direction and the Z-axis direction, a first X-axis resistor element and a first Z-axis resistor element are disposed on one of the X-axis flexible portions on a side of the outer frame portion, and a second X-axis resistor element and a second Z-axis resistor element are disposed on the one of the X-axis flexible portions on a side of the weight portion. Further, in order to detect acceleration components in the X-axis direction and the Z-axis direction, a third X-axis resistor element and a third Z-axis resistor element are disposed on the other of the X-axis flexible portions on a side of the weight portion, and a fourth X-axis resistor element and a fourth Z-axis resistor element are disposed on the other of the X-axis flexible portions on a side of the outer frame portion.

Further, the first to fourth X-axis resistor elements and the first to fourth Z-axis resistor elements are arranged linearly on both sides of the centerline, respectively. The first to fourth X-axis resistor elements, the first to fourth Y-axis resistor elements, and the first to fourth Z-axis resistor elements constitute bridge circuit, respectively, for detecting the acceleration components in the X-axis direction, the Y-axis direction, and the Z-axis direction, respectively (refer to Patent Reference). Patent Reference: Japanese Patent Publication No. 2003-279592

As described above, in the conventional semiconductor acceleration sensor, the first to fourth X-axis resistor elements and the first to fourth Z-axis resistor elements are arranged linearly on the X-axis flexible portions on both sides of the centerline thereof, respectively. Accordingly, when acceleration is applied only in the Z-axis direction, the X-axis flexible portions are twisted due to the acceleration in the Z-axis direction. As a result, in addition to an acceleration component in the Y-axis direction output from the bridge circuit (Wheatstone bridge circuit) formed of the first to fourth Y-axis resistor elements, an acceleration component in the Z-axis direction is also output from the bridge circuit formed of the first to fourth Z-axis resistor elements and disposed on the X-axis flexible portions. That is, there is generated cross-axis sensitivity, i.e., a ratio of the acceleration component in the Z-axis direction with respect to the acceleration component in the Y-axis direction.

When the cross-axis sensitivity is generated, an error in a vector direction may occur due to the cross-axis sensitivity not detected in a normal condition, thereby lowering detection sensitivity of the semiconductor acceleration sensor.

The cross-axis sensitivity will be explained in more detail next with reference to the accompanying drawings.

FIG. 10 is a schematic plan view showing a conventional semiconductor acceleration sensor 1. FIG. 11 is a schematic sectional view of the conventional semiconductor acceleration sensor taken along a line 11-11 in FIG. 10. In a production process, a semiconductor wafer is cut and divided to produce the semiconductor acceleration sensor 1 individually.

The conventional semiconductor acceleration sensor 1 is provided with an outer frame portion 2 formed of silicon (Si) and having a square shape in a plan view. A weight portion 3 is disposed at a center portion of the outer frame portion 2. As shown in FIG. 11, the weight portion 3 has a thickness slightly smaller that that of the outer frame portion 2. As shown in FIG. 10, the weight portion 3 has each side arranged in parallel to each inner side of the outer frame portion 2.

As shown in FIG. 10, an X-axis 5 is defined on an upper surface la of the semiconductor acceleration sensor 1. The X-axis 5 passes through a weight center Wo, i.e., a geometric center of the upper surface la of the weight portion 3, and perpendicularly crosses one side and an opposite side of the weight portion 3. A Y-axis 6 is also defined on the upper surface la of the semiconductor acceleration sensor 1. The Y-axis 6 perpendicularly crosses the X-axis 5 at the weight center Wo.

The semiconductor acceleration sensor 1 is provided with a pair of X-axis flexible portions 7a and 7b. As shown in FIG. 10, the X-axis flexible portions 7a and 7b are arranged such that a centerline thereof is aligned with the X-axis 5. The X-axis flexible portions 7a and 7b are beam members with flexibility formed of silicon and having a small thickness. The X-axis flexible portions 7a and 7b connect between the outer frame portion 2 and the weight portion 3, so that the weight portion 3 is flexibly supported to be movable.

The semiconductor acceleration sensor 1 is further provided with a pair of Y-axis flexible portions 7c and 7d. Similar to the X-axis flexible portions 7a and 7b, the Y-axis flexible portions 7c and 7d are arranged such that a centerline thereof is aligned with the Y-axis 6. The Y-axis flexible portions 7c and 7d are beam members having a function similar to that of the X-axis flexible portions 7a and 7b.

The semiconductor acceleration sensor 1 is further provided with resistor elements 9. The resistor elements 9 are piezo resistor elements formed in surface layers of the X-axis flexible portions 7a and 7b and the Y-axis flexible portions 7c and 7d. An impurity is introduced into the surface layers of the X-axis flexible portions 7a and 7b and the Y-axis flexible portions 7c and 7d to produce the resistor elements 9.

The resistor elements 9 are disposed at portions of the X-axis flexible portions 7a and 7b and the Y-axis flexible portions 7c and 7d near the outer frame portion 2 and the weight portion 3, respectively. The portions of the X-axis flexible portions 7a and 7b and the Y-axis flexible portions 7c and 7d tend to generate a large stress when the weight portion 3 moves or is displaced. Each four of the resistor elements 9 constitute a bridge circuit for converting deformation of the X-axis flexible portions 7a and 7b and the Y-axis flexible portions 7c and 7d into a potential difference, so that an acceleration component can be detected.

In the semiconductor acceleration sensor 1, the resistor elements 9 on the X-axis constitute the bridge circuit for detecting the acceleration component in the X-axis direction. In this case, the resistor elements 9 include a first X-axis resistor element Rx1, a second X-axis resistor element Rx2, a third X-axis resistor element Rx3, and a fourth X-axis resistor element Rx4.

Similarly, the resistor elements 9 on the Y-axis constitute the bridge circuit for detecting the acceleration component in the Y-axis direction. In this case, the resistor elements 9 include a first Y-axis resistor element Ry1, a second Y-axis resistor element Ry2, a third Y-axis resistor element Ry3, and a fourth Y-axis resistor element Ry4.

Further, the resistor elements 9 on the Z-axis constitute the bridge circuit for detecting the acceleration component in the Z-axis direction perpendicularly crossing the X-axis 5 and the Y-axis 6. The z-axis is also perpendicular to the upper surface 1a, i.e., a surface including the X-axis 5 and the Y-axis 6. In this case, the resistor elements 9 include a first Z-axis resistor element Rz1, a second Z-axis resistor element Rz2, a third Z-axis resistor element Rz3, and a fourth Z-axis resistor element Rz4. In FIGS. 10 to 15, the first to fourth Z-axis resistor elements Rz1 to Rz4 are shown as a rectangular graphic with hatching.

In the semiconductor acceleration sensor 1, the first to fourth X-axis resistor elements Rx1 to Rx4, the first to fourth Y-axis resistor elements Ry1 to Ry4, and the first to fourth Z-axis resistor elements Rz1 to Rz4 are arranged as shown in FIG. 10. That is, on one of the X-axis flexible portions 7a and 7b, i.e., the X-axis flexible portion 7a, the first X-axis resistor element Rx1 is disposed on a side of the outer frame portion 2, and the second X-axis resistor element Rx2 is disposed on a side of the weight portion 3. Further, on the other of the X-axis flexible portions 7a and 7b, i.e., the X-axis flexible portion 7b, the third X-axis resistor element Rx3 is disposed on a side of the weight portion 3, and the fourth X-axis resistor element Rx4 is disposed on a side of the outer frame portion 2. The first to fourth X-axis resistor elements Rx1 to Rx4 are arranged in a row on the X-axis 5, i.e., a centerline in a width direction.

In the semiconductor acceleration sensor 1, on one of the Y-axis flexible portions 7c and 7d, i.e., the Y-axis flexible portion 7c, the first Y-axis resistor element Ry1 and the first Z-axis resistor element Rz1 are disposed on a side of the outer frame portion 2, and the second Y-axis resistor element Ry2 and the second Z-axis resistor element Rz2 are disposed on a side of the weight portion 3.

Further, on the other of the Y-axis flexible portions 7c and 7d, i.e., the Y-axis flexible portion 7d, the third Y-axis resistor element Ry3 and the third Z-axis resistor element Rz3 are disposed on a side of the weight portion 3, and the fourth Y-axis resistor element Ry4 and the fourth Z-axis resistor element Rz4 are disposed on a side of the outer frame portion 2.

As shown in FIG. 12, the first and second Y-axis resistor elements Ry1 and Ry2 and the first and second Z-axis resistor elements Rz1 and Rz2 are arranged oppositely with the Y-axis 6, i.e., a centerline in a width direction, at a middle thereof. Further, the first and second Y-axis resistor elements Ry1 and Ry2 and the first and second Z-axis resistor elements Rz1 and Rz2 are arranged such that centers thereof are apart from the centerline in the width direction by a distance B (separation distance B).

As shown in FIG. 12, the first and second Y-axis resistor elements Ry1 and Ry2 and the first and second Z-axis resistor elements Rz1 and Rz2 are arranged such that ends of the first and second Y-axis resistor elements Ry1 and Ry2 and the first and second Z-axis resistor elements Rz1 and Rz2 are apart by a distance C from base portions of the Y-axis flexible portion 7c, or boundaries between the Y-axis flexible portion 7c and the outer frame portion 2 and between the Y-axis flexible portion 7c and the weight portion 3. The distance C is also referred to as a base distance C, and is within a range of 0 to 20 μm.

When acceleration is applied to the semiconductor acceleration sensor 1 in the Z-axis direction, the weight portion 3 moves in parallel in the Z-axis direction as shown in FIG. 13. Accordingly, a tensile stress is applied to the first Z-axis resistor element Rz1 and the fourth Z-axis resistor element Rz4 disposed on the side of the outer frame portion 2. Further, a compressive stress is applied to the second Z-axis resistor element Rz2 and the third Z-axis resistor element Rz3 disposed on the side of the weight portion 3. As a result, according to each stress state, a resistance value of each of the Z-axis resistor elements is changed.

As shown in FIG. 14(a), the first to fourth Z-axis resistor elements Rz1 to Rz4 form a bridge circuit. In the bridge circuit, a power source Vdd is connected to a portion between the first Z-axis resistor element Rz1 and the second Z-axis resistor element Rz2, and an earth Vss is connected to a portion between the third Z-axis resistor element Rz3 and the fourth Z-axis resistor element Rz4.

In the bridge circuit, when acceleration is applied to the semiconductor acceleration sensor 1 in the Z-axis direction, a voltage V1 between the first Z-axis resistor element Rz1 and the third Z-axis resistor element Rz3 and a voltage V2 between the second Z-axis resistor element Rz2 and the fourth Z-axis resistor element Rz4 are changed according to the resistance values changed due to the stresses. A difference between the voltages V1 and V2 is detected as the acceleration component in the Z-axis direction.

When acceleration is applied to the semiconductor acceleration sensor 1 in the X-axis direction, the weight portion 3 is rotated due to the acceleration in the X-axis direction as shown in FIG. 15. Accordingly, a tensile stress is applied to the first X-axis resistor element Rx1 and the third X-axis resistor element Rx3 disposed on the side of the outer frame portion 2. Further, a compressive stress is applied to the second X-axis resistor element Rx2 and the fourth X-axis resistor element Rx4 disposed on the side of the weight portion 3. As a result, according to each stress state, a resistance value of each of the X-axis resistor elements is changed.

As shown in FIG. 14(b), the first to fourth X-axis resistor elements Rx1 to Rx4 form a bridge circuit. In the bridge circuit, a power source Vdd is connected to a portion between the first X-axis resistor element Rx1 and the second X-axis resistor element Rx2, and an earth Vss is connected to a portion between the third X-axis resistor element Rx3 and the fourth X-axis resistor element Rx4.

In the bridge circuit, when acceleration is applied to the semiconductor acceleration sensor 1 in the X-axis direction, a voltage V1 between the first X-axis resistor element Rx1 and the fourth X-axis resistor element Rx4 and a voltage V2 between the second X-axis resistor element Rx2 and the third X-axis resistor element Rx3 are changed according to the resistance values changed due to the stresses. A difference between the voltages V1 and V2 is detected as the acceleration component in the X-axis direction.

When acceleration is applied to the semiconductor acceleration sensor 1 in the X-axis direction opposite to the state shown in FIG. 15, stress states opposite to those described above are created, and an opposite acceleration component is detected.

When acceleration is applied to the semiconductor acceleration sensor 1 in the Y-axis direction, the weight portion 3 is rotated similar to the case in the X-axis direction. In particular, accompanied with the rotation of the weight portion 3, the Y-axis flexible portions 7c and 7d are twisted. Accordingly, a twisting stress is applied to each of the first to fourth Z-axis resistor elements Rz1 to Rz4 disposed on the Y-axis flexible portions 7c and 7d and apart from the centerline by the separation distance B.

In this case, the cross-axis sensitivity is generated according to a difference between the bridge circuit of the Z-axis resistor elements and a bridge circuit of the Y-axis resistor elements. In particular, there is a difference in arrangements between the third and fourth Z-axis resistor elements Rz3 and Rz4 and the third and fourth Y-axis resistor elements Ry3 and Ry4.

A simulation of the cross-axis sensitivity is conducted using the finite element method in the semiconductor acceleration sensor 1 shown in FIG. 10. FIGS. 16(a) and 16(b) are graphs showing simulation results of the cross-axis sensitivity. In the simulation, acceleration of 1.0 G is applied in the X-axis direction, and a ratio of the Z-axis acceleration component to the X-axis acceleration component is calculated.

In FIGS. 16(a) and 16(b), the horizontal axis represents the separation distance B, and the vertical axis represents the ratio (%) of the Z-axis acceleration component relative to the X-axis acceleration component. In the simulation, the separation distance B is set to 2.0, 6.0, and 12 μm. Each of the X-axis flexible portions 7a and 7b and Y-axis flexible portions 7c and 7d has a length of 370 μm, a width of 86 μm, and a thickness of 6.5 μm. The weight portion 3 has a thickness of 340 μm and a weight of 2.4 mg. Each of the resistor elements 9 has a length of 45 μm and a width of 3.0 μm. The base distance C is set to 10 μm.

As shown in FIG. 16(a), when the separation distance B increases, the cross-axis sensitivity increases. For example, when the separation distance B is 2.0 μm (the resistor elements 9 are arranged apart by 4.0 μm, or the opposite edges of the Y-axis resistor elements Ry and the Z-axis resistor elements Rz are apart by 1.0 μm), about 0.5% of the cross-axis sensitivity is still generated.

FIG. 16(b) is a graph showing a simulation result under an assumption in which the weight portion 3 is shifted in the X-axis direction (upward in FIG. 10) due to a positional shift of a resist mask during a manufacturing process of the semiconductor acceleration sensor 1.

As shown in FIG. 16(b), similar to the case shown in FIG. 16(a), when the separation distance B increases, the cross-axis sensitivity increases. A similar result is obtained when the Z-axis resistor elements Rz together with the X-axis resistor elements Rx are disposed on the X-axis flexible portions 7a and 7b.

As described above, in the conventional semiconductor acceleration sensor 1, the first to fourth X-axis resistor elements Rx1 to Rx4 and the first to fourth Z-axis resistor elements Rz1 to Rz4 are arranged in a row on the both sides of the centerline, respectively. Accordingly, when the separation distance B varies or the weight portion 3 is shifted due to a machining variance during the manufacturing process, the cross-axis sensitivity tends to increase. As a result, the acceleration component in the Z-axis direction, which is not supposed to be detected, is generated together with the acceleration component in the X-axis direction, thereby deteriorating detection sensitivity of the acceleration component.

In view of the problems described above, an object of the present invention is to provide an acceleration sensor with improved sensitivity even though a machining variance occurs during a manufacturing process.

Further objects and advantages of the invention will be apparent from the following description of the invention.

### SUMMARY OF THE INVENTION

In order to attain the objects described above, according to the present invention, a semiconductor acceleration sensor includes an outer frame portion; a weight portion disposed at a center portion of the outer frame portion, and having an X-axis and a Y-axis crossing the X-axis perpendicularly at a center point of the weight portion; first to fourth X-axis resistor elements for detecting an acceleration component in an X-axis direction; first to fourth Y-axis resistor elements for detecting an acceleration component in a Y-axis direction; first to fourth Z-axis resistor elements for detecting an acceleration component in a Z-axis direction perpendicularly crossing the X-axis direction and the Y-axis direction; a pair of X-axis flexible portions having a centerline in a width direction thereof along the X-axis for connecting the weight portion and the outer frame portion; and a pair of Y-axis flexible portions having a centerline in a width direction thereof along the Y-axis for connecting the weight portion and the outer frame portion.

In the semiconductor acceleration sensor, the first X-axis resistor element is disposed on one of the X-axis flexible portions on a side of the outer frame portion, and the second X-axis resistor element is disposed on the one of the X-axis flexible portions on a side of the weight portion. Further, the third X-axis resistor element is disposed on the other of the X-axis flexible portions on a side of the weight portion, and the fourth X-axis resistor element is disposed on the other of the X-axis flexible portions on a side of the outer frame portion.

In the semiconductor acceleration sensor, the first Y-axis resistor element is disposed on one of the Y-axis flexible portions on a side of the outer frame portion, and the second Y-axis resistor element is disposed on the one of the Y-axis flexible portions on a side of the weight portion. Further, the third Y-axis resistor element is disposed on the other of the Y-axis flexible portions on a side of the weight portion, and the fourth Y-axis resistor element is disposed on the other of the Y-axis flexible portions on a side of the outer frame portion.

In the semiconductor acceleration sensor, the first to fourth Z-axis resistor elements are disposed on ones of the X-axis flexible portions and the Y-axis flexible portions. Further, the first to fourth Z-axis resistor elements are arranged oppositely with respect to ones of the first to fourth X-axis resistor elements and the first to fourth Y-axis resistor elements in the width direction with the centerline inbetween. Further, the first and second Z-axis resistor elements are arranged symmetrically with respect to the third and fourth Z-axis resistor elements with the center point of the weight portion as a symmetrical center.

In the present invention, even though a machining variance occurs on the semiconductor acceleration sensor during a manufacturing process, it is possible to absorb the machining variance and maintain constant cross-axis sensitivity regardless of a separation distance. Further, it is possible to minimize the cross-axis sensitivity, thereby improving acceleration detection sensitivity of the semiconductor acceleration sensor.

### BRIEF DESCRIPTION OF THE DRAWINGS

FIG. 1 is a schematic plan view showing a semiconductor acceleration sensor according to a first embodiment of the present invention;

FIGS. 2(a) and 2(b) are graphs showing simulation results of cross-axis sensitivity of the semiconductor acceleration sensor according to the first embodiment of the present invention;

FIGS. 3(a) to 3(d) are schematic views showing a process of producing the semiconductor acceleration sensor according to the first embodiment of the present invention;

FIG. 4 is a schematic plan view showing a semiconductor acceleration sensor according to a second embodiment of the present invention;

FIGS. 5(a) and 5(b) are graphs showing simulation results of cross-axis sensitivity of the semiconductor acceleration sensor according to the second embodiment of the present invention;

FIG. 6 is a schematic plan view showing another example of the semiconductor acceleration sensor according to the second embodiment of the present invention;

FIG. 7 is a schematic plan view showing a semiconductor acceleration sensor according to a third embodiment of the present invention;

FIG. 8 is a schematic plan view showing another example of the semiconductor acceleration sensor according to the third embodiment of the present invention;

FIG. 9 is a schematic plan view showing a further example of the semiconductor acceleration sensor according to the third embodiment of the present invention;

FIG. 10 is a schematic plan view showing a conventional semiconductor acceleration sensor;

FIG. 11 is a schematic sectional view of the conventional semiconductor acceleration sensor taken along a line 11-11 in FIG. 10;

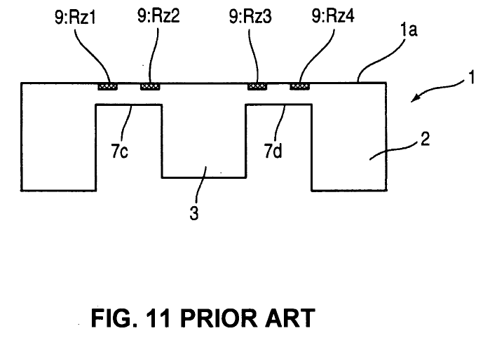

FIG. 12 is a generic schematic plan view showing a flexible portion of a semiconductor acceleration sensor;

FIG. 13 is a generic schematic view showing a semiconductor acceleration sensor detecting acceleration in a Z-axis direction;

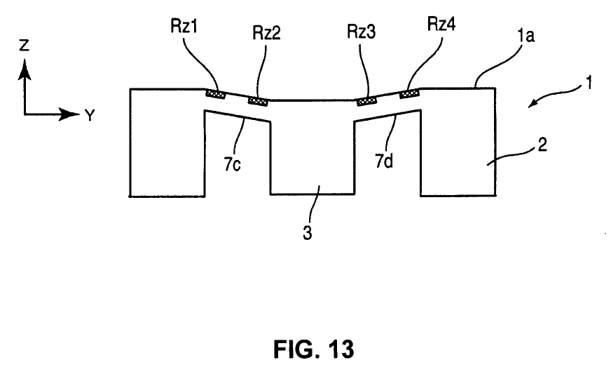

FIGS. 14(a) and 14(b) are generic schematic views showing bridge circuits of a semiconductor acceleration sensor;

FIG. 15 is a generic schematic view showing a semiconductor acceleration sensor detecting acceleration in a Z-axis direction; and

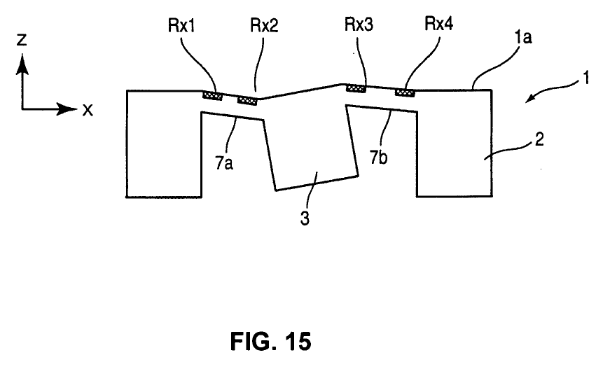

FIGS. 16(a) and 16(b) are graphs showing simulation results of cross-axis sensitivity of the conventional semiconductor acceleration sensor.

### DETAILED DESCRIPTION OF PREFERRED EMBODIMENTS

Hereunder, embodiments of the present invention will be explained with reference to the accompanying drawings.

### First Embodiment

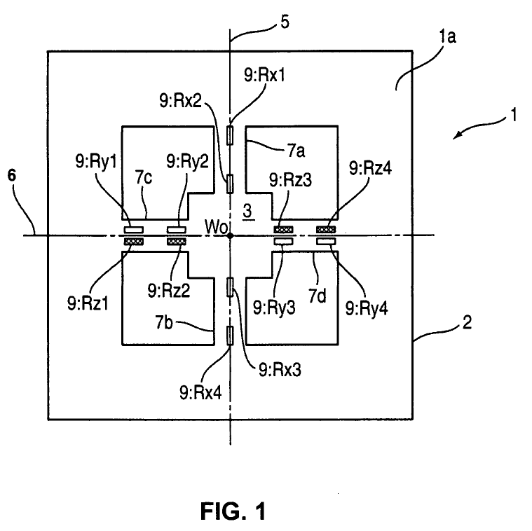

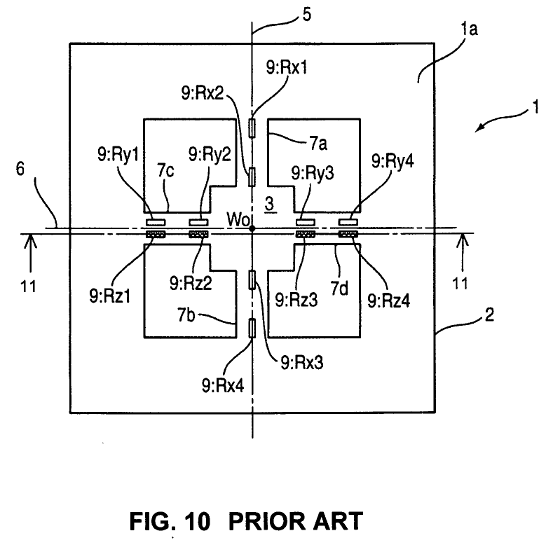

FIG. 1 is a schematic plan view showing a semiconductor acceleration sensor 1 according to a first embodiment of the present invention. Components similar to those in a conventional semiconductor acceleration sensor 1 shown in FIG. 10 are designated by the same numeral references, and explanations thereof are omitted.

In the semiconductor acceleration sensor 1 shown in FIG. 1, X-axis resistor elements 9 are arranged similar to the conventional semiconductor acceleration sensor 1 shown in FIG. 10. In particular, first to fourth X-axis resistor elements Rx1 to Rx4 are arranged linearly in a row on X-axis flexible portions 7a and 7b on a centerline thereof (X-axis 5) in a width direction thereof.

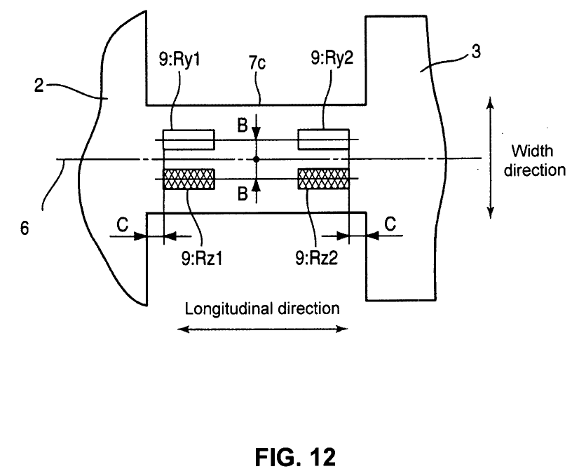

In the embodiment, a first Y-axis resistor element Ry1 and a first Z-axis resistor element Rz1 are disposed on a Y-axis flexible portion 7c on a side of an outer frame portion 2, such that the first Y-axis resistor element Ry1 and the first Z-axis resistor element Rz1 are arranged oppositely with a centerline (Y-axis 6) in a width direction inbetween and away from the centerline by a separation distance B (refer to FIG. 12). A second Y-axis resistor element Ry2 and a second Z-axis resistor element Rz2 are disposed on a Y-axis flexible portion 7d on a side of a weight portion 3, such that the second Y-axis resistor element Ry2 and the second Z-axis resistor element Rz2 are arranged oppositely with the centerline (Y-axis 6) in the width direction inbetween and away from the centerline by the separation distance B (refer to FIG. 12).

In the embodiment, a third Y-axis resistor element Ry3, a fourth Y-axis resistor element Ry4, a third Z-axis resistor element Rz3, and a fourth Z-axis resistor element Rz4 are disposed on the Y-axis flexible portion 7d. Further, the first and second Y-axis resistor elements Ry1 and Ry2 disposed on the Y-axis flexible portion 7c are arranged symmetrically with respect to the third and fourth Y-axis resistor elements Ry3 and Ry4 disposed on the Y-axis flexible portion 7d with a center point Wo of the weight portion 3 as a symmetrical center. Similarly, the first and second Z-axis resistor elements Rz1 and Rz2 disposed on the Y-axis flexible portion 7c are arranged symmetrically with respect to the third and fourth Z-axis resistor elements Rz3 and Rz4 disposed on the Y-axis flexible portion 7d with the center point Wo of the weight portion 3 as a symmetrical center.

That is, as shown in FIG. 1, the third Z-axis resistor element Rz3 is arranged on an upper side of the Y-axis flexible portion 7d above the centerline thereof (side of the X-axis flexible portion 7a) on a side of the weight portion 3. The third Y-axis resistor element Ry3 is arranged on a lower side of the Y-axis flexible portion 7d below the centerline thereof (side of the X-axis flexible portion 7b) on the side of the weight portion 3. Further, the third Z-axis resistor element Rz3 and the third Y-axis resistor element Ry3 are arranged oppositely away from the centerline by the separation distance B.

Similarly, the fourth Z-axis resistor element Rz4 is arranged on the upper side of the Y-axis flexible portion 7d above the centerline thereof on a side of the outer frame portion 2. The fourth Y-axis resistor element Ry4 is arranged on the lower side of the Y-axis flexible portion 7d below the centerline thereof on the side of the outer frame portion 2. Further, the fourth Z-axis resistor element Rz4 and the fourth Y-axis resistor element Ry4 are arranged oppositely away from the centerline by the separation distance B.

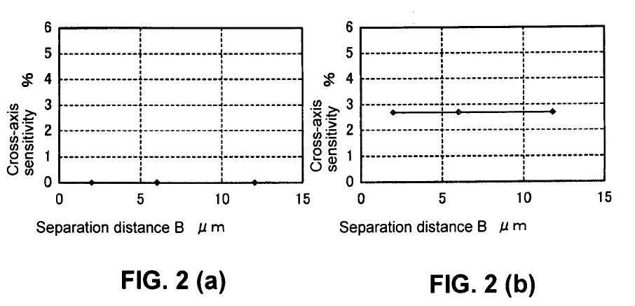

In the semiconductor acceleration sensor 1 with the resistor elements 9 arranged as describe above, cross-axis sensitivity is simulated. FIGS. 2(a) and 2(b) are graphs showing simulation results of the cross-axis sensitivity of the semiconductor acceleration sensor 1 according to the first embodiment of the present invention.

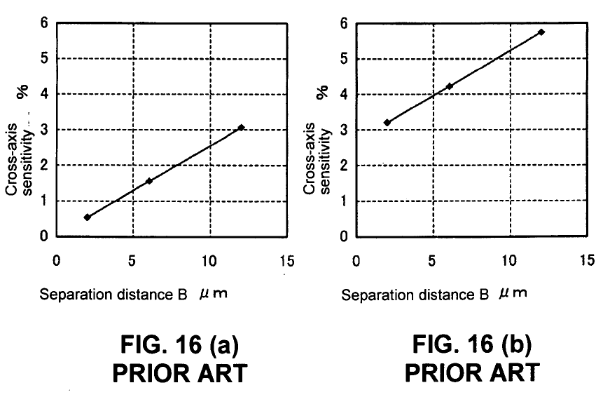

In the simulation, similar to the simulation results shown in FIGS. 16(a) and 16(b), the separation distance B is set to 2.0, 6.0, and 12 μm. Each of the X-axis flexible portions 7a and 7b and Y-axis flexible portions 7c and 7d has a length of 370 μm, a width of 86 μm, and a thickness of 6.5 μm. The weight portion 3 has a thickness of 340 μm and a weight of 2.4 mg. Each of the resistor elements 9 has a length of 45 μm and a width of 3.0 μm. A base distance C is set to 10 μm. A difference from the simulation shown in FIGS. 16(a) and 16(b) is the arrangements of the first to fourth Y-axis resistor elements Ry1 to Ry4 and the first to fourth Z-axis resistor elements Rz1 to Rz4.

Further, in FIGS. 2(a) and 2(b), similar to FIGS. 16(a) and 16(b), the horizontal axis represents the separation distance B, and the vertical axis represents the ratio (%) of the Z-axis acceleration component to the X-axis acceleration component.

As shown in FIG. 2(a), in the semiconductor acceleration sensor 1 with the resistor elements 9 arranged as describe above, when the weight portion 3 is not shifted, the cross-sensitivity remains constant at zero while the separation distance B varies. Further, as shown in FIG. 2(b), even when the weight portion 3 is shifted in the X-axis direction by 15 μm, the cross-sensitivity remains less than 3% regardless of the separation distance B.

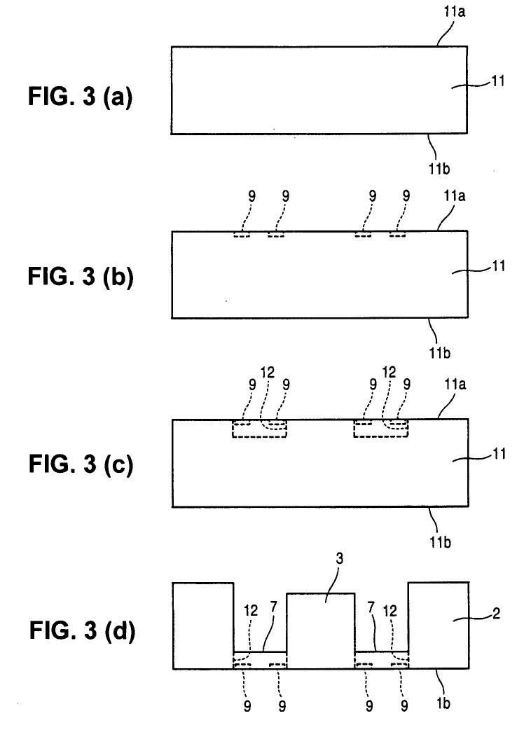

A process of producing the semiconductor acceleration sensor 1 will be explained next. FIGS. 3(a) to 3(d) are schematic views showing the process of producing the semiconductor acceleration sensor 1 according to the first embodiment of the present invention.

As shown in FIG. 3(a), first, a semiconductor wafer 11 formed of silicon is prepared. In the next step, as shown in FIG. 3(b), a resist mask having an opening portion is formed on an upper surface 11a of the semiconductor wafer 11 in forming areas of the resistor elements 9 with lithography. Then, a specific impurity is introduced to form the resistor elements 9 in a front layer of the semiconductor wafer 11.

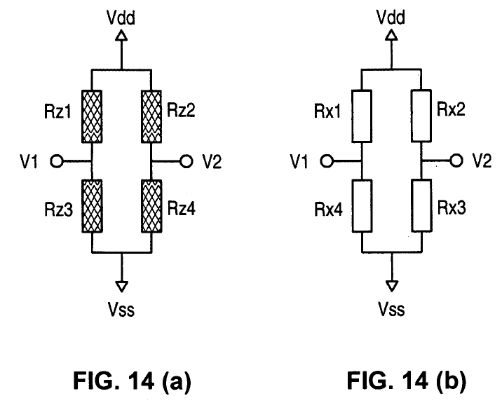

In the next step, the resist mask is removed, and a wiring pattern is formed, so that the resistor elements 9 constitute bridge circuits shown in FIGS. 14(a) and 14(b). FIGS. 14(a) and 14(b) are schematic views showing the bridge circuits of the semiconductor acceleration sensor 1.

In the next step, as shown in FIG. 3(c), a resist mask is formed with lithography for covering forming areas of the outer frame portion 2, the flexible portions 7a to 7d, and the weight portion 3 on the upper surface 11a of the semiconductor wafer 11. Then, the semiconductor wafer 11 is etched through anisotropy etching and the like up to a depth larger than a thickness of the flexible portions 7a to 7d, so that upper patterns 12 of the outer frame portion 2, the flexible portions 7a to 7d, and the weight portion 3 are formed.

In the next step, as shown in FIG. 3(d), the resist mask formed in the previous step is removed, and the semiconductor wafer 11 is turned over. A resist mask is formed on a backside surface 11b of the semiconductor wafer 11 for exposing inner areas of the outer frame portion 2. Then, the backside surface 11b of the semiconductor wafer 11 is etched through anisotropy etching and the like, so that the weight portion 3 has a specific thickness.

In the next step, a resist mask is formed with lithography for covering a forming area of the weight portion 3 on the upper surface 11a of the semiconductor wafer 11. Then, the backside surface 11b of the semiconductor wafer 11 is further etched between the weight portion 3 and inner portions of the outer frame portion 2, so that the backside surface patterns pass through the upper surface patterns 12. Accordingly, the flexible portions 7a to 7d have a specific thickness, thereby forming the flexible portions 7a to 7d.

After the resist mask is removed, the semiconductor wafer 11 is divided into pieces with a dicing blade (not shown) to form an outer shape of the outer frame portion 2, thereby producing the semiconductor acceleration sensor 1.

As described above, in the embodiment, the first to fourth Z-axis resistor elements Rz1 to Rz4 are disposed according to the specific arrangement. Accordingly, even though the Y-axis flexible portions 7c and 7d are twisted, a resistor balance of the first to fourth Z-axis resistor elements Rz1 to Rz4 is maintained. As a result, even though the separation distance B varies or the weight portion 3 is shifted due to a positional shift of the upper surface patterns 12 and the backside surface patterns during the manufacturing process of the weight portion 3, it is possible to maintain the cross-axis sensitivity less than 3% regardless of the separation distance B, thereby improving acceleration detection sensitivity of the semiconductor acceleration sensor 1.

In the embodiment, it is possible to maintain the cross-axis sensitivity constant regardless of the separation distance B. Accordingly, it is possible to determine the forming locations of the resistor elements 9 in consideration of other factors such as sensitivity and temperature characteristics.

In the process of producing the semiconductor acceleration sensor 1, the wiring patterns for forming the bridge circuits of the resistor elements 9 may be simply changed without implementing a special process or facility. Accordingly, it is possible to produce the semiconductor acceleration sensor 1 with the reduced cross-axis sensitivity using the existing production facility without deteriorating production efficiency.

In the embodiment, the first to fourth Z-axis resistor elements Rz1 to Rz4 are disposed on the Y-axis flexible portions 7c and 7d. Alternatively, the first to fourth Z-axis resistor elements Rz1 to Rz4 may be disposed on the X-axis flexible portions 7a and 7b with the same arrangement.

As described above, in the embodiment, the first to fourth Z-axis resistor elements Rz1 to Rz4 are disposed on, for example, the Y-axis flexible portions 7c and 7d. Further, the first to fourth Z-axis resistor elements Rz1 to Rz4 are arranged oppositely with respect to the first to fourth Y-axis resistor elements Ry1 to Ry4 in the width direction with the centerline inbetween. Further, the first and second Z-axis resistor elements Rz1 and Rz2 are arranged symmetrically with respect to the third and fourth Z-axis resistor elements Rz3 and Rz4 with the center point of the weight portion as a symmetrical center.

Accordingly, even though a machining variance occurs on the semiconductor acceleration sensor 1 during the manufacturing process, it is possible to absorb the machining variance and maintain constant the cross-axis sensitivity regardless of the separation distance B. Further, it is possible to minimize the cross-axis sensitivity, thereby improving acceleration detection sensitivity of the semiconductor acceleration sensor 1.

### Second Embodiment

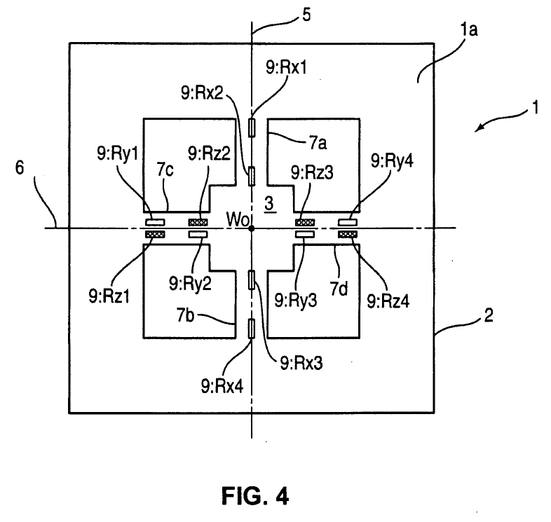

A second embodiment of the present invention will be explained next. FIG. 4 is a schematic plan view showing the semiconductor acceleration sensor 1 according to the second embodiment of the present invention. Components in the second embodiment similar to those in the first embodiment are designated by the same reference numerals, and explanations thereof are omitted.

In the second embodiment, as shown in FIG. 4, similar to the first embodiment, the first to fourth X-axis resistor elements Rx1 to Rx4 are arranged linearly in a row on the X-axis flexible portions 7a and 7b on the centerline thereof (X-axis 5) in the width direction thereof.

In the embodiment, the first and second Y-axis resistor elements Ry1 and Ry2 and the first and second Z-axis resistor elements Rz1 and Rz2 are disposed alternately on the Y-axis flexible portion 7c oppositely in the width direction with the centerline (Y-axis 6) inbetween. Further, the third and fourth Y-axis resistor elements Ry3 and Ry4 and the third and fourth Z-axis resistor elements Rz3 and Rz4 are disposed alternately on the Y-axis flexible portion 7d oppositely in the width direction with the centerline inbetween.

That is, as shown in FIG. 4, the first Y-axis resistor element Ry1 is arranged on the upper side of the Y-axis flexible portion 7c above the centerline thereof (side of the X-axis flexible portion 7a) on the side of the outer frame portion 2. The first Z-axis resistor element Rz1 is arranged on the lower side of the Y-axis flexible portion 7d below the centerline thereof (side of the X-axis flexible portion 7b) on the side of the outer frame portion 2. Further, the first Y-axis resistor element Ry1 and the first Z-axis resistor element Rz1 are arranged oppositely away from the centerline by the separation distance B.

Similarly, the second Z-axis resistor element Rz2 is arranged on the upper side of the Y-axis flexible portion 7c above the centerline thereof on the side of the weight portion 3. The second Y-axis resistor element Ry2 is arranged on the lower side of the Y-axis flexible portion 7c below the centerline thereof on the side of the weight portion 3. Further, the second Z-axis resistor element Rz2 and the second Y-axis resistor element Ry2 are arranged oppositely away from the centerline by the separation distance B.

Further, the third Z-axis resistor element Rz3 is arranged on the upper side of the Y-axis flexible portion 7d above the centerline thereof on the side of the weight portion 3. The third Y-axis resistor element Ry3 is arranged on the lower side of the Y-axis flexible portion 7d below the centerline thereof on the side of the weight portion 3. Further, the third Y-axis resistor element Ry3 and the third Z-axis resistor element Rz3 are arranged oppositely away from the centerline by the separation distance B.

Similarly, the fourth Y-axis resistor element Ry4 is arranged on the upper side of the Y-axis flexible portion 7d above the centerline thereof on the side of the outer frame portion 2. The fourth Z-axis resistor element Rz4 is arranged on the lower side of the Y-axis flexible portion 7d below the centerline thereof on the side of the outer frame portion 2. Further, the fourth Y-axis resistor element Ry4 and the fourth Z-axis resistor element Rz2 are arranged oppositely away from the centerline by the separation distance B.

As described above, in the embodiment, the first to fourth Y-axis resistor elements Ry1 to Ry4 and the first to fourth Z-axis resistor elements Rz1 to Rz4 are disposed alternately on the Y-axis flexible portions 7c and 7d.

Further, the first and second Y-axis resistor elements Ry1 and Ry2 disposed on the Y-axis flexible portion 7c are arranged symmetrically with respect to the third and fourth Y-axis resistor elements Ry3 and Ry4 disposed on the Y-axis flexible portion 7d with the X-axis 5 perpendicularly crossing the Y-axis 6 or the centerline at the center point Wo of the weight portion 3 as a symmetrical line. Similarly, the first and second Z-axis resistor elements Rz1 and Rz2 disposed on the Y-axis flexible portion 7c are arranged symmetrically with respect to the third and fourth Z-axis resistor elements Rz3 and Rz4 disposed on the Y-axis flexible portion 7d with the X-axis 5 perpendicularly crossing the Y-axis 6 or the centerline at the center point Wo of the weight portion 3 as a symmetrical line.

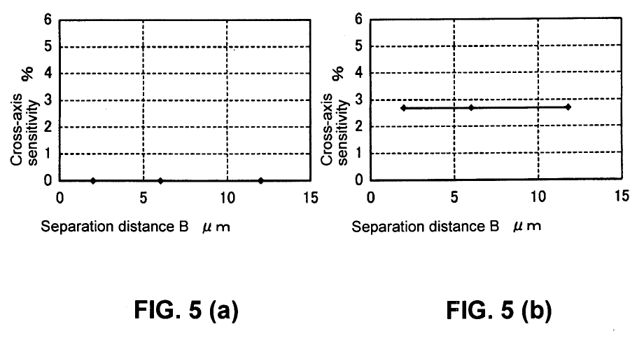

In the semiconductor acceleration sensor 1 with the resistor elements 9 arranged as describe above, the cross-axis sensitivity is simulated. FIGS. 5(a) and 5(b) are graphs showing simulation results of the cross-axis sensitivity of the semiconductor acceleration sensor 1 according to the first embodiment of the present invention.

In the simulation, conditions and dimensions similar to the simulation results shown in FIGS. 16(a) and 16(b) are used. A difference from the simulation shown in FIGS. 16(a) and 16(b) is the arrangements of the first to fourth Y-axis resistor elements Ry1 to Ry4 and the first to fourth Z-axis resistor elements Rz1 to Rz4.

Further, in FIGS. 5(a) and 5(b), similar to FIGS. 16(a) and 16(b), the horizontal axis represents the separation distance B, and the vertical axis represents the ratio (%) of the Z-axis acceleration component to the X-axis acceleration component.

As shown in FIG. 5(a), similar to the first embodiment, in the semiconductor acceleration sensor 1 with the resistor elements 9 arranged as describe above, when the weight portion 3 is not shifted, the cross-sensitivity remains constant at zero while the separation distance B varies. Further, as shown in FIG. 5(b), even when the weight portion 3 is shifted in the X-axis direction by 15 μm, the cross-sensitivity remains less than 3% regardless of the separation distance B.

A process of producing the semiconductor acceleration sensor 1 is similar to that in the first embodiment, and a detailed explanation thereof is omitted. In the process, as shown in FIG. 3(b), a resist mask is formed on the semiconductor wafer for forming the bridge circuits of the resistor elements 9 arranged in the arrangement different from that in the first embodiment.

As described above, in the second embodiment, the first and second Y-axis resistor elements Ry1 and Ry2 and the first and second Z-axis resistor elements Rz1 and Rz2 are disposed alternately on the Y-axis flexible portion 7c oppositely in the width direction with the centerline inbetween. Further, the third and fourth Y-axis resistor elements Ry3 and Ry4 and the third and fourth Z-axis resistor elements Rz3 and Rz4 are disposed alternately on the Y-axis flexible portion 7d oppositely in the width direction with the centerline inbetween.

Further, the first and second Z-axis resistor elements Rz1 and Rz2 disposed on the Y-axis flexible portion 7c are arranged symmetrically with respect to the third and fourth Z-axis resistor elements Rz3 and Rz4 disposed on the Y-axis flexible portion 7d with the X-axis 5 perpendicularly crossing the Y-axis 6 at the center point Wo as a symmetrical line. Accordingly, it is possible to obtain effects same as those in the first embodiment.

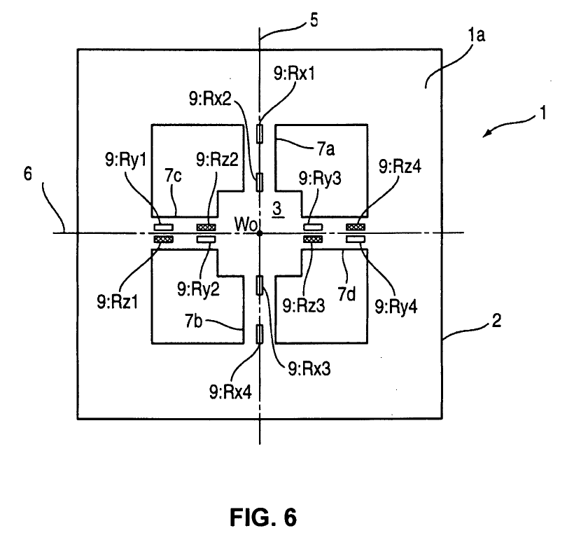

In the second embodiment, the first to fourth Y-axis resistor elements Ry1 to Ry4 and the first to fourth Z-axis resistor elements Rz1 to Rz4 are disposed alternately on the Y-axis flexible portions 7c and 7d. Further, the first to fourth Y-axis resistor elements Ry1 to Ry4 and the first to fourth Z-axis resistor elements Rz1 to Rz4 are arranged symmetrically with the X-axis 5 perpendicularly crossing the Y-axis 6 at the center point Wo as a symmetrical line. Alternatively, as shown in FIG. 6, the first to fourth Y-axis resistor elements Ry1 to Ry4 and the first to fourth Z-axis resistor elements Rz1 to Rz4 disposed alternately are arranged symmetrically with the center point Wo as a symmetrical center.

### Third Embodiment

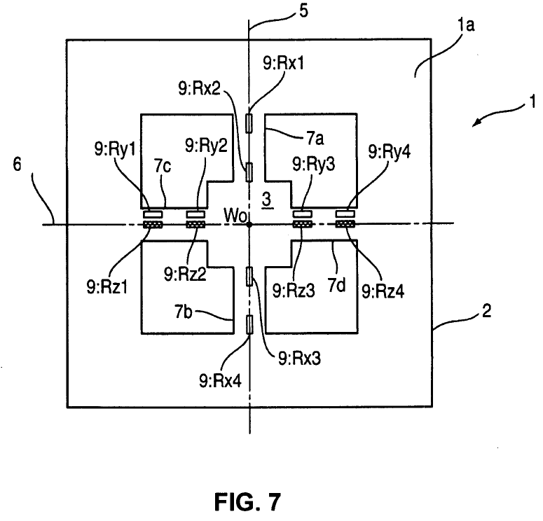

A third embodiment of the present invention will be explained next. FIG. 7 is a schematic plan view showing the semiconductor acceleration sensor 1 according to the third embodiment of the present invention. Components in the third embodiment similar to those in the first embodiment are designated by the same reference numerals, and explanations thereof are omitted.

In the third embodiment, as shown in FIG. 7, similar to the first embodiment, the first to fourth X-axis resistor elements Rx1 to Rx4 are arranged linearly in a row on the X-axis flexible portions 7a and 7b on the centerline thereof (X-axis 5) in the width direction thereof.

In the embodiment, the first Z-axis resistor element Rz1 is arranged on the Y-axis flexible portion 7c on the side of the outer frame portion 2. The second Z-axis resistor element Rz2 is arranged on the Y-axis flexible portion 7c on the side of the weight portion 3. Similarly, the third Z-axis resistor element Rz3 is arranged on the Y-axis flexible portion 7d on the side of the weight portion 3. The fourth Z-axis resistor element Rz4 is arranged on the Y-axis flexible portion 7d on the side of the outer frame portion 2. Further, the first to fourth Z-axis resistor elements Rz1 to Rz4 are arranged linearly in a row on the Y-axis 6 or the centerline in the width direction.

In the embodiment, the first to fourth Y-axis resistor element Ry1 to Ry4 are arranged in a row on the Y-axis flexible portions 7c and 7d on an upper side (side of the X-axis flexible portion 7a) of the first to fourth Z-axis resistor element Rz1 to Rz4 arranged in a row on the centerline.

In other words, in the embodiment, the first to fourth Z-axis resistor element Rz1 to Rz4 are arranged on the centerline of the Y-axis flexible portions 7c and 7d, and the first to fourth Y-axis resistor element Ry1 to Ry4 are arranged oppositely thereto in the width direction. Accordingly, the third and fourth Y-axis resistor elements Ry3 and Ry4 disposed on the Y-axis flexible portion 7d are arranged symmetrically with respect to the first and second Y-axis resistor elements Ry1 and Ry2 disposed on the Y-axis flexible portion 7c with the X-axis 5 perpendicularly crossing the Y-axis 6 at the center point Wo of the weight portion 3 as a symmetrical line.

As described above, in the embodiment, the first to fourth Z-axis resistor elements Rz1 to Rz4 are disposed in a row on the centerline. Accordingly, even though the Y-axis flexible portions 7c and 7d are twisted, stress states generated in the first to fourth Z-axis resistor elements Rz1 to Rz4 due to the twisting force become substantially equal. As a result, when the separation distance B is zero, or the weight portion 3 is not shifted, the cross-axis sensitivity becomes substantially zero. Even though the weight portion 3 is shifted, the cross-axis sensitivity is maintained less than 3%.

A process of producing the semiconductor acceleration sensor 1 in the third embodiment is similar to that in the first embodiment, and a detailed explanation thereof is omitted. In the process, as shown in FIG. 3(b), a resist mask is formed on the semiconductor wafer for forming the bridge circuits of the resistor elements 9 arranged in the arrangement different from that in the first embodiment.

As described above, the first to fourth Z-axis resistor element Rz1 to Rz4 are arranged on the centerline of the Y-axis flexible portions 7c and 7d, or the X-axis flexible portions 7a and 7b. Further, the first and second Y-axis resistor elements Ry1 and Ry2 are arranged symmetrically with respect to the third and fourth Y-axis resistor elements Ry3 and Ry4 with the X-axis 5 perpendicularly crossing at the center point Wo as a symmetrical line. Accordingly, it is possible to obtain effects same as those in the first embodiment.

In the embodiment, the first to fourth Y-axis resistor elements Ry1 to Ry4 disposed on the Y-axis flexible portions 7c and 7d are arranged symmetrically with the X-axis 5 as a symmetrical line. The arrangement is not limited thereto, and the first to fourth Y-axis resistor elements Ry1 to Ry4 may be arranged in a row below the first to fourth Z-axis resistor elements Rz1 to Rz4, contrary to that in FIG. 7.

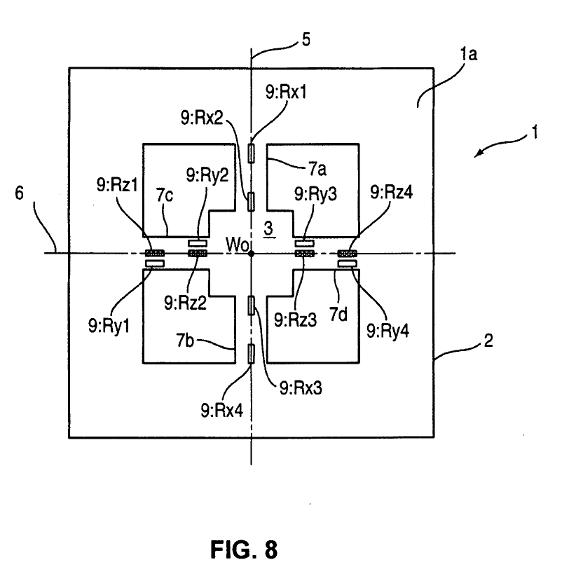

Further, as shown in FIG. 8, the first to fourth Y-axis resistor elements Ry1 to Ry4 may be arranged alternately on the upper side and the lower side with respect to the first to fourth Z-axis resistor elements Rz1 to Rz4. With these arrangements, it is possible to obtain effects same as those in the first embodiment.

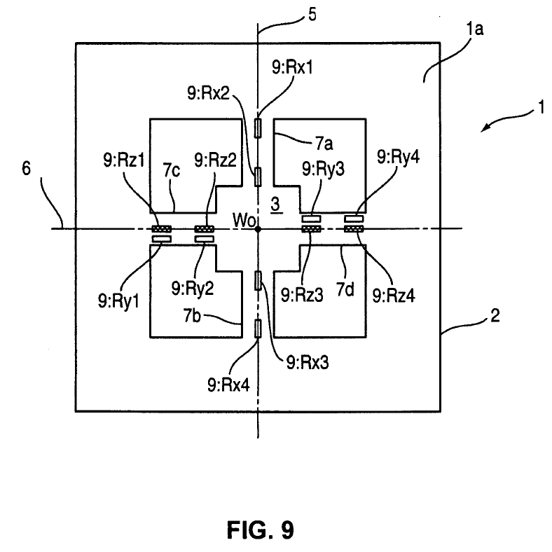

Further, as shown in FIG. 9, the first to fourth Y-axis resistor elements Ry1 to Ry4 may be arranged symmetrically with the center point Wo as a symmetrical center. Still further, the first to fourth Y-axis resistor elements Ry1 to Ry4 may be arranged symmetrically in a symmetric arrangement contrary to that in FIG. 9. With these arrangements, it is possible to obtain effects same as those in the first embodiment.

In the embodiments described above, each of the resistor elements 9 is disposed away from the boundary between the flexible portions 7a to 7d and the outer frame portion 2, or the flexible portions 7a to 7d and the weight portion 3, by the base distance C of 0 to 20 μm. The invention is not limited thereto, and one or both ends of each of the resistor elements 9 may be disposed over the outer frame portion 2 or the weight portion 3.

The disclosure of Japanese Patent Application No. 2006-185895, filed on Jul. 05, 2006, is incorporated in the application by reference.

While the invention has been explained with reference to the specific embodiments of the invention, the explanation is illustrative and the invention is limited only by the appended claims.

What is claimed is:

1. A semiconductor acceleration sensor, comprising:
an outer frame portion;
a weight portion disposed at a center portion of the outer frame portion, and having an X-axis and a Y-axis crossing the X-axis perpendicularly at a center point of the weight portion;
first to fourth X-axis resistor elements for detecting an acceleration component in an X-axis direction;
first to fourth Y-axis resistor elements for detecting an acceleration component in a Y-axis direction;
first to fourth Z-axis resistor elements for detecting an acceleration component in a Z-axis direction perpendicularly crossing the X-axis direction and the Y-axis direction;
a pair of X-axis flexible portions having a first centerline in a width direction thereof along the X-axis for connecting the weight portion and the outer frame portion; and
a pair of Y-axis flexible portions having a second centerline in a width direction thereof along the Y-axis for connecting the weight portion and the outer frame portion,
wherein the first X-axis resistor element is disposed on one of the X-axis flexible portions on a side of the outer frame portion; the second X-axis resistor element is disposed on the one of the X-axis flexible portions on a side of the weight portion; the third X-axis resistor element is disposed on the other of the X-axis flexible portions on a side of the weight portion; and the fourth X-axis resistor element is disposed on the other of the X-axis flexible portions on a side of the outer frame portion,
wherein the first Y-axis resistor element is disposed on one of the Y-axis flexible portions on a side of the outer frame portion; the second Y-axis resistor element is disposed on the one of the Y-axis flexible portions on a side of the weight portion; the third Y-axis resistor element is disposed on the other of the Y-axis flexible portions on a side of the weight portion; and the fourth Y-axis resistor element is disposed on the other of the Y-axis flexible portions on a side of the outer frame portion,
wherein the first to fourth Z-axis resistor elements are disposed on ones of the X-axis flexible portions and the Y-axis flexible portions; the first to fourth Z-axis resistor elements are arranged oppositely with respect to ones of the first to fourth X-axis resistor elements and the first to fourth Y-axis resistor elements in the width direction of the ones of the X-axis flexible portions and the Y-axis flexible portions with one of the first centerline and the second centerline inbetween; and the first and second Z-axis resistor elements are arranged symmetrically with respect to the third and fourth Z-axis resistor elements with the center point of the weight portion as a symmetrical point.

2. A semiconductor acceleration sensor, comprising:
an outer frame portion;
a weight portion disposed at a center portion of the outer frame portion, and having an X-axis and a Y-axis crossing the X-axis perpendicularly at a center point of the weight portion;
first to fourth X-axis resistor elements for detecting an acceleration component in an X-axis direction;
first to fourth Y-axis resistor elements for detecting an acceleration component in a Y-axis direction;
first to fourth Z-axis resistor elements for detecting an acceleration component in a Z-axis direction perpendicularly crossing the X-axis direction and the Y-axis direction;
a pair of X-axis flexible portions having a first centerline in a width direction thereof along the X-axis for connecting the weight portion and the outer frame portion; and
a pair of Y-axis flexible portions having a second centerline in a width direction thereof along the Y-axis for connecting the weight portion and the outer frame portion,
wherein the first X-axis resistor element is disposed on one of the X-axis flexible portions on a side of the outer frame portion; the second X-axis resistor element is disposed on the one of the X-axis flexible portions on a side of the weight portion; the third X-axis resistor element is disposed on the other of the X-axis flexible portions on a side of the weight portion; and the fourth X-axis resistor element is disposed on the other of the X-axis flexible portions on a side of the outer frame portion,
wherein the first Y-axis resistor element is disposed on one of the Y-axis flexible portions on a side of the outer frame portion; the second Y-axis resistor element is disposed on the one of the Y-axis flexible portions on a side of the weight portion; the third Y-axis resistor element is disposed on the other of the Y-axis flexible portions on a side of the weight portion; and the fourth Y-axis resistor element is disposed on the other of the Y-axis flexible portions on a side of the outer frame portion,
wherein the first and second Z-axis resistor elements are arranged alternately with respect to ones of the first and second X-axis resistor elements and the first and second Y-axis resistor elements oppositely in the width direction of ones of the X-axis flexible portions and the Y-axis flexible portions with one of the first centerline and the second centerline inbetween; and the third and fourth Z-axis resistor elements are arranged alternately with respect to ones of the third and fourth X-axis resistor elements and the third and fourth Y-axis resistor elements oppositely in the width direction of the ones of the X-axis flexible portions and the Y-axis flexible portions with the one of the first centerline and the second centerline inbetween.

3. The semiconductor acceleration sensor according to claim 2, wherein said first and second Z-axis resistor elements are arranged symmetrically with respect to the third and fourth Z-axis resistor elements with one of the X-axis and the Y-axis perpendicularly crossing the one of the first centerline and the second centerline as a symmetrical axis.

4. The semiconductor acceleration sensor according to claim 2, wherein said first and second Z-axis resistor elements are arranged symmetrically with respect to the third and fourth Z-axis resistor elements with the center point of the weight portion as a symmetrical point.

5. A semiconductor acceleration sensor, comprising:
an outer frame portion;
a weight portion disposed at a center portion of the outer frame portion, and having an X-axis and a Y-axis crossing the X-axis perpendicularly at a center point of the weight portion;
first to fourth X-axis resistor elements for detecting an acceleration component in an X-axis direction;
first to fourth Y-axis resistor elements for detecting an acceleration component in a Y-axis direction;
first to fourth Z-axis resistor elements for detecting an acceleration component in a Z-axis direction perpendicularly crossing the X-axis direction and the Y-axis direction;
a pair of X-axis flexible portions having a first centerline in a width direction thereof along the X-axis for connecting the weight portion and the outer frame portion; and
a pair of Y-axis flexible portions having a second centerline in a width direction thereof along the Y-axis for connecting the weight portion and the outer frame portion,
wherein the first X-axis resistor element is disposed on one of the X-axis flexible portions on a side of the outer frame portion; the second X-axis resistor element is disposed on the one of the X-axis flexible portions on a side of the weight portion; the third X-axis resistor element is disposed on the other of the X-axis flexible portions on a side of the weight portion; and the fourth X-axis resistor element is disposed on the other of the X-axis flexible portions on a side of the outer frame portion,
wherein the first Y-axis resistor element is disposed on one of the Y-axis flexible portions on a side of the outer frame portion; the second Y-axis resistor element is disposed on the one of the Y-axis flexible portions on a side of the weight portion; the third Y-axis resistor element is disposed on the other of the Y-axis flexible portions on a side of the weight portion; and the fourth Y-axis resistor element is disposed on the other of the Y-axis flexible portions on a side of the outer frame portion,
wherein the first to fourth Z-axis resistor elements are disposed on ones of the X-axis flexible portions and the Y-axis flexible portions; the first to fourth Z-axis resistor elements are arranged oppositely with respect to ones of the first to fourth X-axis resistor elements and the first to fourth Y-axis resistor elements in the width direction of the ones of the X-axis flexible portions and the Y-axis flexible portions; and the first to fourth Z-axis resistor elements are arranged in a row on one of the first centerline and the second centerline.

6. The semiconductor acceleration sensor according to claim 5, wherein said first and second Z-axis resistor elements are arranged symmetrically with respect to the third and fourth Z-axis resistor elements with one of the X-axis and the Y-axis perpendicularly crossing the one of the first centerline and the second centerline as a symmetrical axis.

7. The semiconductor acceleration sensor according to claim 5, wherein said first and second Z-axis resistor elements are arranged symmetrically with respect to the third and fourth Z-axis resistor elements with the center point of the weight portion as a symmetrical point.

8. A semiconductor acceleration sensor, comprising:
an outer frame portion;
a weight portion disposed at a center portion of the outer frame portion, and having a center point;
a pair of flexible portions for connecting the weight portion and the outer frame portion, one of said flexible portions extending between the weight portion and the outer frame portion in a first direction, the other of said flexible portions extending between the weight portion and the outer frame portion in the first direction;
a plurality of first resistor elements for detecting an acceleration component in a first direction, said first resistor elements being arranged symmetrically on the flexible portions with the center point as a symmetrical point; and
a plurality of second resistor elements for detecting an acceleration component in a second direction crossing the first direction perpendicularly, said second resistor elements being disposed in a number same as that of the first resistor elements.

9. The semiconductor acceleration sensor according to claim 8, wherein said second resistor elements are arranged symmetrically on the flexible portions with the center point as a symmetrical point.

10. A semiconductor acceleration sensor, comprising:
an outer frame portion;
a weight portion disposed at a center portion of the outer frame portion, and having a center point;
a pair of flexible portions for connecting the weight portion and the outer frame portion, one of said flexible portions extending between the weight portion and the outer frame portion in a first direction, the other of said flexible portions extending between the weight portion and the outer frame portion in the first direction;
a plurality of first resistor elements for detecting an acceleration component in a first direction, said first resistor elements being arranged symmetrically on the flexible portions with the center point as a symmetrical line; and
a plurality of second resistor elements for detecting an acceleration component in a second direction crossing the first direction perpendicularly, said second resistor elements being disposed in a number same as that of the first resistor elements.

11. The semiconductor acceleration sensor according to claim 10, wherein said second resistor elements are arranged symmetrically on the flexible portions with the center point as a symmetrical line.
